(19) United States
(12) Patent Application Publication
(10) Pub. No.: US 2026/0225548 A1
(43) Pub. Date: Aug. 6, 2026

(54) A CONTROL SYSTEM FOR A LOUDSPEAKER SYSTEM

(71) Applicant: Jaguar Land Rover Limited, Whitley, Coventry, Warwickshire (GB)

(72) Inventors: Daniel CLARKE, Coventry, West Midlands (GB); Callum HUBBARD, Coventry, West Midlands (GB)

(21) Appl. No.: 19/158,291

(22) PCT Filed: Feb. 13, 2024
(86) PCT No.: PCT/EP2024/053611

§ 371 Date: Aug. 20, 2025

(30) Foreign Application Priority Data
Feb. 21, 2023 (GB) 2302424.3

(51) Int. Cl. B60R 16/037; B60R 11/02; H04R 3/12; H04R 5/02; H04R 5/04

(52) U.S. Cl. CPC B60R 16/0373; B60R 11/0217; H04R 3/12; H04R 5/02; H04R 5/04; H04R 2430/01; H04R 2499/13

(57) ABSTRACT

Aspects and embodiments of the invention relate to a control system, a vehicle, a method, and computer-readable instructions. The control system is for controlling a loudspeaker system of the vehicle. In a first operating mode the control system is configured to deactivate the loudspeaker system in dependence on a powertrain of the vehicle entering a deactivated state. In a second operating mode the control system is configured to enable the loudspeaker system to be used while the powertrain is in the deactivated state. The control system is configured to: receive a mode-transition voice command requesting the second operating mode, from any one of a first vehicle microphone and a second vehicle microphone; determine whether an entry condition is satisfied; and output a control signal to initiate a mode transition to the second operating mode, in dependence on the entry condition being satisfied.

### TECHNICAL FIELD

The present disclosure relates to mode-transition voice commands to enable use of vehicle loudspeakers while a powertrain is in a deactivated state. Aspects of the invention relate to a control system, a vehicle, a method, and computer-readable instructions.

### BACKGROUND

Tailgate parties and similar leisure activities involve users congregating around or occupying rear cargo areas of parked vehicles. Users may listen to music or watch films or sporting events, for example. Some users may utilise vehicle electrical battery power from an auxiliary battery or a high-capacity electrified vehicle battery.

Configuring a vehicle for a tailgate party may require user action. For example, a driver of the vehicle may configure various settings in an infotainment system, and they may open the vehicle tailgate. At the end of the tailgate party, the driver may close the vehicle tailgate and lock the vehicle.

It is an aim of the present invention to address one or more of the disadvantages associated with the prior art.

### SUMMARY OF THE INVENTION

Aspects and embodiments of the invention provide a control system, a vehicle, and computer-readable instructions as claimed in the appended claims.

According to an aspect of the invention, there is provided a control system for controlling a loudspeaker system of a vehicle, the control system comprising one or more controllers, wherein in a first operating mode the control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the control system is configured to:
receive a mode-transition voice command from any one of a first vehicle microphone and a second vehicle microphone, wherein the first vehicle microphone is arranged to detect voice input from a first location in the vehicle, wherein the second vehicle microphone is arranged to detect voice input from a second location in the vehicle, wherein the mode-transition voice command requests the second operating mode;
determine whether an entry condition is satisfied, wherein the entry condition is different depending on which one of the first and second vehicle microphones the mode-transition voice command was received from; and
output a control signal to initiate a mode transition to the second operating mode, in dependence on the entry condition being satisfied.

An advantage is that the second operating mode can be voice-activated from more than one location in the vehicle, while enabling one location such as a driver location to have more ‘authority’ than the other location. Therefore, a technical effect is improved control over how the second operating mode is activated.

The closure may be a tailgate closure of the vehicle and the second operating mode may be configured for tailgate events (tailgate parties).

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to perform any one or more of the method(s) described herein, including: receiving the mode transition voice-command; determining whether the entry condition is satisfied; and outputting the control signal.

The entry condition may enable the mode transition regardless of whether the closure is in the open state or a closed state when the mode-transition voice command is from the first vehicle microphone. The entry condition may enable the mode transition if the closure is in the open state but not if the closure is in the closed state when the mode-transition voice command is from the second vehicle microphone.

An advantage is that a user at the second location, such as a passenger location, is not completely prohibited from voice-activating the second operating mode, because their request will be allowed if the closure is already open. However, only users at the first location, such as a driver location, have the authority to decide whether the closure should be open or closed.

The control system may be configured to receive an indication of a degree of opening of the closure from a closure sensor of the vehicle, and determine whether the degree of opening of the closure is greater than a threshold value between fully closed and fully open values. The entry condition may enable the mode transition if the degree of opening of the closure is greater than the threshold when the mode-transition voice command is from the second vehicle microphone.

An advantage is that the user at the second location can voice-activate the second operating mode without the closure needing to be open to its maximum extent.

The control system may be configured to control an actuator of the vehicle to move the closure of the vehicle between open and closed positions, when transitioning between the first and second operating modes.

An advantage is that only a user at the first location, such as a driver location, has the authority to cause automatic opening of the closure.

When the entry condition is satisfied, the control system may be configured to output a control signal to cause an output device to prompt a user to provide a closure-actuation initiation input, and control the actuator to move the closure of the vehicle between the open and closed positions in dependence on receiving the closure-actuation initiation input.

An advantage is that the user is guided/prompted to reduce the likelihood of the closure colliding with an obstruction as the closure is actuated. The prompt reminds the user to check for obstructions that might be in the path of the closure. This is useful where a collision sensor for the closure can only detect collisions that have already occurred, rather than predicting potential collisions.

The second location may be closer to the closure of the vehicle than the first location. The second vehicle microphone may be closer to the closure of the vehicle than the first vehicle microphone. The first vehicle microphone may comprise a front cabin microphone arranged to detect voice inputs from the first location, the first location comprising a driver's seat. The second vehicle microphone may comprise a rear cabin microphone arranged to detect voice inputs from the second location, the second location comprising a rear seat behind the driver's seat.

An advantage is that the second operating mode can be voice-activated by rear passengers without giving them as much authority as the driver. For example, as described above, only the driver may be allowed to voice-activate the second operating mode if doing so would involve opening of the closure. Further, where the first vehicle microphone is further away from the closure than the second vehicle microphone, this ensures that users standing outside the vehicle near the closure are less likely to be detected issuing a voice command that would cause automatic opening of the closure.

The control system may be configured to:
receive a second mode-transition voice command from the second vehicle microphone, wherein the second mode-transition voice command requests the first operating mode while the control system is in the second operating mode; and
output a control signal to initiate a second mode transition to the first operating mode, in dependence on receiving the second mode-transition voice command. The control system may be configured to enable the second mode transition regardless of whether the closure is open or closed when the second mode-transition voice command is from the second vehicle microphone.

An advantage is convenience because at the end of a tailgate event, users are likely to be in the vicinity of the closure and may not intend to re-enter the vehicle to be within detection range of the first vehicle microphone. Therefore, being able to deactivate the second operating mode from outside the vehicle using the proximal second vehicle microphone is convenient.

In the second operating mode, the control system may be configured to control the loudspeaker system to direct audio output to a vehicle-rearward location relative to audio output in the first operating mode.

An advantage is that the vehicle is better equipped for tailgate events. In this aspect, users can receive a good sound quality at reasonable volume levels while congregating at the rear cargo area of the vehicle.

Directing audio output to the vehicle-rearward location may comprise activating or increasing a sound pressure level of a rear loudspeaker of the loudspeaker system relative to a front loudspeaker of the loudspeaker system, and/or deactivating or decreasing the sound pressure level of the front loudspeaker of the loudspeaker system.

The second operating mode may require one or more of the following conditions to be satisfied:
an internal combustion engine of the powertrain is in a non-running state;
the vehicle is secured in a stationary position by a holding device of the vehicle; or
an electrical energy storage means of the vehicle has an above-threshold state of charge.

An advantage is minimising vehicle emissions during the tailgate event, and not requiring the vehicle to have an auxiliary battery.

According to another aspect of the invention, there is provided a vehicle comprising the control system.

According to a further aspect of the invention, there is provided a method of controlling a loudspeaker system of a vehicle, wherein in a first operating mode a control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the method comprises:
receiving a mode-transition voice command from any one of a first vehicle microphone and a second vehicle microphone, wherein the first vehicle microphone is arranged to detect voice input from a first location in the vehicle, wherein the second vehicle microphone is arranged to detect voice input from a second location in the vehicle, wherein the mode-transition voice command requests the second operating mode;
determining whether an entry condition is satisfied, wherein the entry condition is different depending on which one of the first and second vehicle microphones the mode-transition voice command was received from; and
outputting a control signal to initiate a mode transition to the second operating mode, in dependence on the entry condition being satisfied.

According to a further aspect of the invention, there is provided a control system for controlling a loudspeaker system of a vehicle, the control system comprising one or more controllers, wherein in a first operating mode the control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the control system is configured to:
receive a mode-transition command from any one of a first vehicle input device and a second vehicle input device, wherein the first vehicle input device is arranged to detect input from a first location in the vehicle, wherein the second vehicle input device is arranged to detect input from a second location in the vehicle, wherein the mode-transition command requests the second operating mode;
determine whether an entry condition is satisfied, wherein the entry condition is different depending on which one of the first and second vehicle input devices the mode-transition command was received from; and
output a control signal to initiate a mode transition to the second operating mode, in dependence on the entry condition being satisfied. The input devices may comprise microphones, touchscreens, or other human-machine interfaces. According to a further aspect of the invention, there is provided a corresponding method and computer-readable instructions.

According to a further aspect of the invention, there is provided a control system for controlling a loudspeaker system of a vehicle, the control system comprising one or more controllers, wherein in a first operating mode the control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the control system is configured to:
receive a mode-transition voice command from any one of a first location in the vehicle and a second location in the vehicle, sensed by one or more microphones, wherein the mode-transition voice command requests the second operating mode;
determine whether an entry condition is satisfied, wherein the entry condition is different depending on which one of the first and second locations the mode-transition voice command was received from; and
output a control signal to initiate a mode transition to the second operating mode, in dependence on the entry condition being satisfied. According to a further aspect of the invention, there is provided a corresponding method and computer-readable instructions.

According to a further aspect of the invention, there is provided a control system for controlling a loudspeaker system of a vehicle, the control system comprising one or more controllers, wherein in a first operating mode the control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the control system is configured to:
receive a mode-transition command from any one of a first location in the vehicle and a second location in the vehicle, sensed by one or more input devices, wherein the mode-transition command requests the second operating mode;
determine whether an entry condition is satisfied; and
output a control signal to initiate a mode transition to the second operating mode, in dependence on the entry condition being satisfied, wherein the control signal is different depending on which one of the first and second locations the mode-transition command was received from. The input devices may comprise microphones, touchscreens, or other human-machine interfaces. For example, where the control signal causes an actuator to open the closure, the difference may be in relation to a speed of opening of the closure, or a target value of a degree of opening of the closure, among other things. According to a further aspect of the invention, there is provided a corresponding method and computer-readable instructions.

According to a further aspect of the invention, there is provided computer readable instructions which, when executed by a computer, are arranged to perform any one or more of the method(s) described herein. According to a further aspect of the invention there is provided a non-transitory computer readable medium comprising computer readable instructions that, when executed by one or more electronic processors, causes the one or more electronic processors to carry out any one or more of the methods described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a system;

FIG. 3A illustrates an example of a control system;

FIG. 3B illustrates an example of a non-transitory computer-readable storage medium;

FIG. 4 illustrates an example of a state diagram; and

FIG. 5 illustrates an example storyboard.

### DETAILED DESCRIPTION

In summary, the Figures illustrate an example of a control system 300 for controlling a loudspeaker system 206 of a vehicle 1, the control system 300 comprising one or more controllers 301. In a first operating mode 402, the control system 300 is configured to deactivate the loudspeaker system 206 in dependence on a powertrain 201 of the vehicle 1 entering a deactivated state. The first operating mode 402 may be a normal or default operating mode for the loudspeaker system 206. In a second operating mode 412, the control system 300 is configured to enable the loudspeaker system 206 to be used while the powertrain 201 is in the deactivated state. The second operating mode 412 requires a closure 506 of the vehicle 1 to be in an open state. In some examples, the closure 506 is a tailgate closure, and the second operating mode 412 is a user-requestable operating mode for extended use of the loudspeaker system 206 during a tailgate event, while the vehicle 1 is not running. The control system 300 is configured to:
receive a mode-transition voice command 404 from any one of a first vehicle microphone 208 and a second vehicle microphone 212, wherein the first vehicle microphone 208 is arranged to detect voice input from a first location in the vehicle 1, wherein the second vehicle microphone 212 is arranged to detect voice input from a second location in the vehicle 1, wherein the mode-transition voice command 404 requests the second operating mode 412;
determine whether an entry condition 406 is satisfied, wherein the entry condition 406 is different depending on which one of the first and second vehicle microphones 208, 212 the mode-transition voice command was received from; and
output a control signal to initiate a mode transition 408 to the second operating mode 412, in dependence on the entry condition being satisfied 406.

The above functionality enables the second operating mode 412 to be voice-controlled from more than one location, but the locations have different levels of permissions. This is useful where different locations in the vehicle 1 are associated with different levels of permissions, such as a driver location versus a passenger location. In the main example implementation described herein, transitioning 408 to the second operating mode 412 for a tailgate event causes automatic opening of the tailgate closure 506, but only the driver has the permission to initiate the automatic opening of the tailgate closure 506. Therefore, voice-activation of the second operating mode 412 from the second location (passenger location) may be handled differently if the tailgate closure 506 is closed at the time of the request. For example, the request may be denied, or responded to by a prompt to open the closure manually or in a supervised/semi-automated way. However, if the tailgate closure 506 is already open at the time of the request, then the second operating mode 412 is activated.

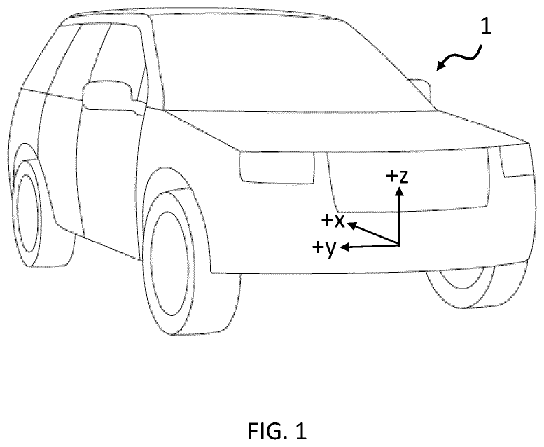

A vehicle 1 in accordance with an embodiment of the present invention is described herein with reference to the accompanying FIG. 1. In some, but not necessarily all examples, the vehicle 1 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 1 representing a centreline, an orthogonal lateral y-axis between left and right lateral sides of the vehicle 1, and a vertical z-axis. A forward/fore direction typically faced by a driver's seat is in the negative x-direction; rearward/aft is +x. A rightward direction as seen from the driver's seat is in the positive y-direction; leftward is −y. These are a first lateral direction and a second lateral direction.

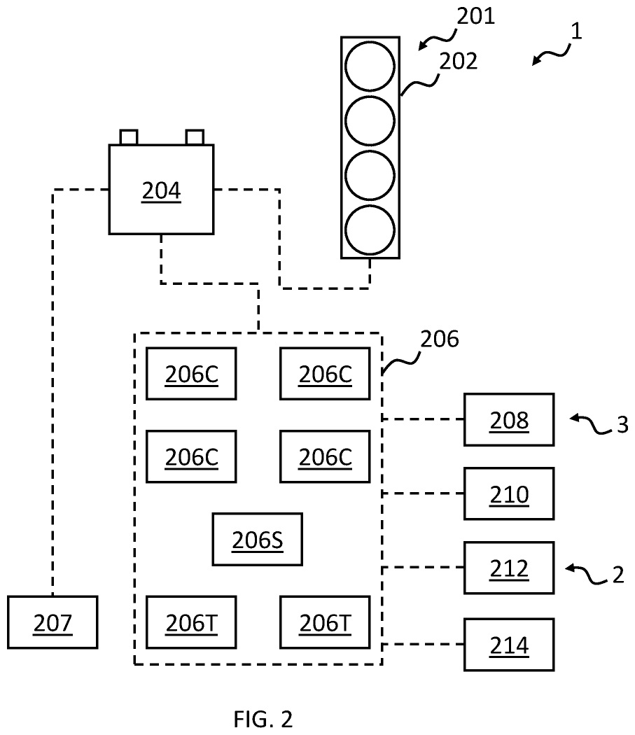

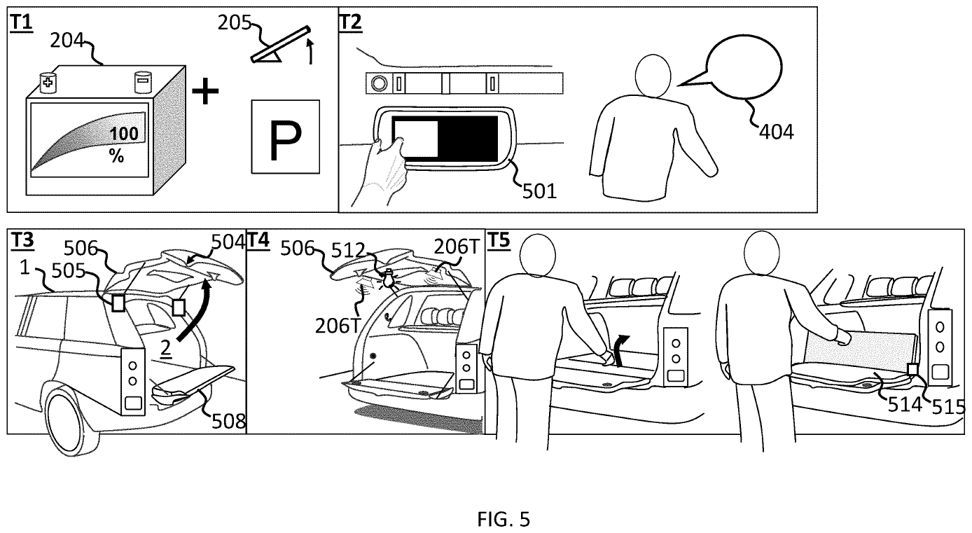

FIG. 2 schematically illustrates vehicle components that are referred to in this specification, and some further components are shown in FIG. 5.

FIG. 2 illustrates a system for the vehicle 1. A powertrain 201 of the vehicle 1 is shown. In the illustrated example, the powertrain 201 comprises an internal combustion engine 202 (‘engine’ or ICE herein). FIG. 2 also illustrates an electrical energy storage means in the form of a battery 204. The battery 204 may be a starting-lighting-ignition battery (SLI battery) having a nominal voltage of less than 30 volts, such as 12 volts.

In another example, the vehicle is a battery electric vehicle (BEV), such that the engine 202 is omitted and replaced with one or more electric machines (not shown). Alternatively, the vehicle 1 may be a hybrid electric vehicle (HEV), the powertrain 201 comprising an engine 202 and one or more electric machines. If the vehicle is a BEV or a plug-in HEV, the battery 204 may have a nominal voltage in the hundreds of volts.

FIG. 2 further illustrates a loudspeaker system 206 of the vehicle 1. The battery 204 is further configured to provide electrical power to the loudspeaker system 206. The illustrated loudspeaker system 206 comprises a set of loudspeakers around the interior of the vehicle 1, including seating area loudspeakers 206C and rear cargo-area loudspeakers 206S, 206T.

The seating area loudspeakers 206C comprise front and rear loudspeakers, for front and rear rows of seats respectively. The rear cargo-area loudspeakers 206S, 206T are rear loudspeakers located aft of the seating area loudspeakers 206C, and are either within the rear cargo area 2 of the vehicle 1, or are otherwise configured to direct audio into the rear cargo area 2 of the vehicle 1.

As shown in FIG. 5, the rear cargo-area loudspeakers 206T can comprise one or more tailgate closure loudspeakers 206T configured to be mounted to an interior side of a tailgate closure 506 of the vehicle 1. The tailgate closure loudspeakers 206T may be dedicated loudspeakers for use in tailgate events.

According to the example of FIG. 5, the tailgate closure loudspeakers 206T are provided on an upper tailgate closure 506 of a split tailgate. The term ‘closure’ refers to a hinged panel for enabling access to the vehicle 1. When a degree of opening of the upper tailgate closure 506 is at a fully open value, the tailgate closure loudspeakers 206T may face at least partially downwards to provide an unobstructed listening experience to a user sitting on a lower tailgate closure 508 of the split tailgate. When the degree of opening of the upper tailgate closure 506 is at a fully closed value (e.g., fully closed position, e.g., latched), the tailgate closure loudspeakers 206T may face forward.

FIG. 2 further illustrates an optional subwoofer 206S which may be located in or near the rear cargo area 2.

The seating area loudspeakers 206C can comprise cabin area loudspeakers facing the cabin 3 of the vehicle 1. Seating area loudspeakers 206C may be mounted to side doors, to an A-pillar or B-pillar, and/or to a dashboard, for example.

FIG. 2 further illustrates vehicle microphones 208, 212. The microphones 208, 212 are operably coupled to the loudspeaker system 206 to enable a hands-free telephony function and/or a hands-free virtual assistant function. One or both of the microphones 208, 212 may be provided as part of an active noise reduction (ANR) system, which may be a function of the control system 300.

The first vehicle microphone 208 can be in the form of a front cabin microphone. The first vehicle microphone 208 is arranged to detect voice input from a first location in the vehicle 1. The first location in the vehicle 1 comprises at least a driver's seat of a front row of seats of the vehicle 1. The first location may comprise an individual front seat (the driver's seat), or a front row of seats. Therefore, the first vehicle microphone 208 is configured for driver use.

To detect voice input from the first location, the first vehicle microphone 208 may be mounted in proximity to the driver's seat of the vehicle 1. For example, the first vehicle microphone 208 may be supported by the dashboard, an A-pillar or B-pillar, a seat structure or a steering wheel.

The second vehicle microphone 212 can be in the form of a rear cabin microphone. The second vehicle microphone 212 is arranged to detect voice input from a second location in the vehicle 1, different from the first location. The second location in the vehicle 1 comprises at least a rear seat, aft of the driver's seat. The second location may comprise an individual rear seat or a row of rear seats. The rear seat may belong to a second or third row of rear seats, depending on the seating configuration of the vehicle 1.

To detect voice input from the second location, the second vehicle microphone 212 may be mounted in proximity to the rear seat of the vehicle 1. For example, the second vehicle microphone 212 may be supported by a roof structure of the vehicle 1, proximal to the vehicle centreline to enable any passengers across the rear row of seats to use the second vehicle microphone 212. The second vehicle microphone 212 may be supported by the roof structure at a location aft of a sunroof of the vehicle 1 (if present). Alternatively, the second vehicle microphone 212 may be mounted elsewhere such as to a B-pillar, or a C-or D-pillar, a side closure (side door), the tailgate closure 506, 508, or a rear seat.

The second vehicle microphone 212 may be positioned closer to the tailgate closure 506 than to the driver's seat of the vehicle 1. The second vehicle microphone 212 may be aligned with a last row of rear seats before a rear cargo area 2 of the vehicle 1, or may be aligned with the rear cargo area 2. The rear cargo area 2 is accessed via the tailgate closure(s) 506, 508.

The second vehicle microphone 212 is at a sufficiently aft location on the vehicle 1, that once the tailgate closure 506, 508 is in an open state, the second vehicle microphone 212 can further detect voice inputs from users congregated outside the vehicle 1 in proximity to the rear cargo area 2 of the vehicle 1. Therefore, during a tailgate event, users can provide voice commands, such as media playback voice commands, without having to get into the vehicle 1 or move toward the first vehicle microphone 208. In other implementations, the second vehicle microphone 212 comprises a dedicated external microphone, to detect voice inputs from users congregated outside the vehicle 1.

As shown in FIG. 2, the vehicle 1 may further comprise a wireless communication interface 210. Audio output through the loudspeaker system 206 may be controllable via the wireless communication interface 210. The wireless communication interface 210 can comprise a short range wireless personal/local area network interface (e.g., Bluetooth™/WiFi™ interface) able to play audio from a user's mobile equipment (hand-portable computing device) through the loudspeaker system 206. This enables a user to control audio during a tailgate event without having to enter the cabin 3 to operate an integrated infotainment system of the vehicle 1.

In addition to the loudspeaker system 206, FIG. 2 further illustrates an optional electrical receptacle 207 of the vehicle 1. In some implementations, the battery 204 is configured to provide electrical power for auxiliary equipment during a tailgate event by providing electrical power to the electrical receptacle 207. In some examples, the electrical receptacle 207 is located in or near the rear cargo area 2 of the vehicle 1.

FIG. 5 illustrates further optional features not shown in FIG. 2, for enhancing a tailgate event. FIG. 5 illustrates a rear cargo area lamp 512 that is activatable to function as a task lamp for illuminating an area in the vicinity of the rear cargo area 2. In some examples, the rear cargo area lamp 512 is integrated with the tailgate closure such as the upper tailgate closure 506. Therefore, when the upper tailgate closure 506 is open, a user sitting on the lower tailgate closure 508 has the benefit of an overhead task lamp.

FIG. 5 further illustrates a tailgate seat 514 supported at least partially by the lower tailgate closure 508. The tailgate seat 514 may comprise a seat base and a seat back. The seat base and/or seat back may be integrated with the rear cargo area 2 or may be a separate part that is attached when needed to a suitable attachment point 515 of the vehicle 1.

As described above, the vehicle 1 is equipped to cater for a tailgate event. According to a control method 400 described below and shown in FIG. 4, the vehicle 1 is switchable between different operating modes including an operating mode configured for a tailgate event.

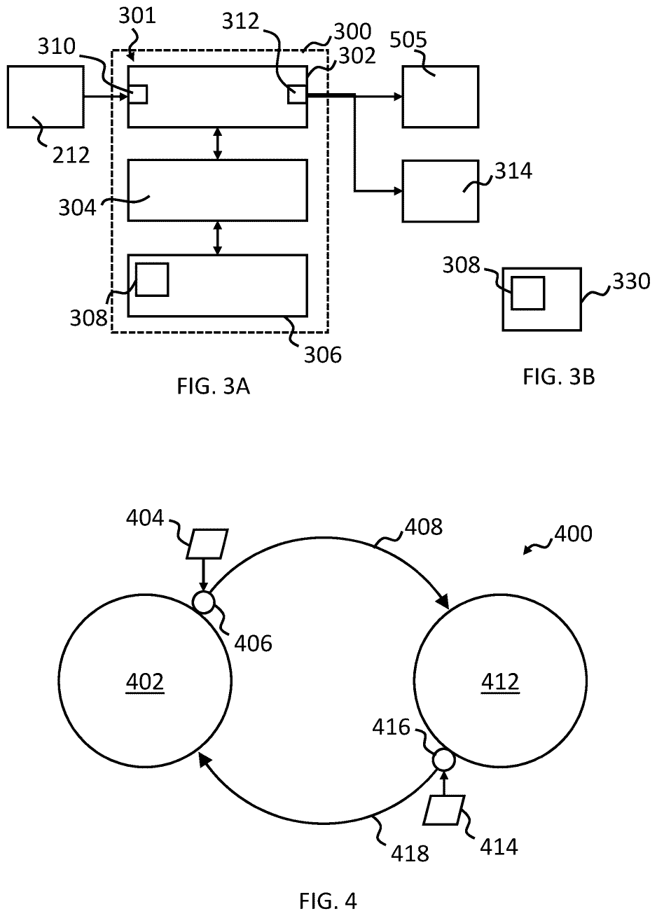

The control method 400 may be executed by a control system 300 as shown in FIG. 3A, or by instructions 308 stored on a non-transitory computer-readable storage medium 330 as shown in FIG. 3B. FIGS. 3A-3B are described in more detail later.

The method 400 is represented by a state diagram illustrative. The state diagram is configured to switch between a first operating mode 402 and a second operating mode 412 based on conditions 406, 416.

As summarised earlier, the first operating mode 402 may be a normal or default operating mode for the loudspeaker system 206. The second operating mode 412 may be a user-requestable operating mode for extended use of the loudspeaker system 206 during a tailgate event, while the vehicle 1 is not running.

In the first operating mode 402, the control system 300 is configured to control the loudspeaker system 206 of the vehicle 1 to direct audio output into the cabin 3 of the vehicle 1. The first operating mode 402 is used for normal driving. For example, audio may be output through the seating area loudspeakers 206C but not the tailgate closure loudspeakers 206T. The tailgate closure loudspeakers 206T may be inactive (substantially no audio output) to reduce energy use, as their sound may otherwise be muffled to those in the cabin 3.

Alternatively, all of the loudspeakers of FIG. 2 may be active and the audio may be faded towards a default front-rear position configured for listening in the cabin 3.

If the user parks the vehicle 1 and deactivates the powertrain 201 of the vehicle 1 and does not wish to have a tailgate event, they will leave the control system 300 in the first operating mode 402. In this situation, the control system 300 may deactivate equipment such as the loudspeaker system 206, the electrical receptacle 207, and/or the wireless communication interface 210 as part of a vehicle 1 shutdown process. They are deactivated immediately or not long after the control system 300 detects that the powertrain 201 of the vehicle 1 has entered a deactivated state. Detecting the deactivated state can comprise any appropriate detection that the vehicle 1 has been switched off such that the powertrain 201 is not operable to drive the vehicle 1, meaning that any user torque demand (e.g., accelerator pedal depression) would not be acted upon. For example, the control system 300 may detect a vehicle-off power mode or similar ‘key-off’ event. The deactivation may occur in response to the vehicle entering a locked or alarmed state, in which the powertrain is deactivated, and subsequently access to the vehicle is limited by the transition to a locked vehicle state.

In the first operating mode 402, deactivation of the loudspeaker system 206 after the deactivation of the powertrain 201 can be controlled by a timer, in some examples. The timer may initiate automatically in dependence on the detection of the deactivation of the powertrain 201. The expiry duration of the timer depends on the implementation, but could be less than ten minutes or less than five minutes to minimise energy drain.

If the user instead wishes to have a tailgate event experience, they may request the second operating mode 412. In the second operating mode 412, the control system 300 is configured, among other things, to control the loudspeaker system 206 of the vehicle 1 to direct audio output to a vehicle-rearward location relative to the audio output in the first operating mode 402, to improve the tailgate listening experience in a tailgate listening zone. For example, the tailgate closure loudspeakers 206T may be activated if previously not active. If the tailgate closure loudspeakers 206T were already active, their sound pressure levels may be increased by fading the audio output towards the rear cargo area 2. The subwoofer 206S may remain active.

In order to prevent the control system 300 from deactivating the loudspeaker system 206 when the powertrain 201 enters the deactivated state, the control system 300 may ignore or interrupt (e.g., pause) the timer if the second operating mode 412 has been entered.

In the second operating mode 412, the loudspeaker system 206 may be available for longer than an hour while the powertrain 201 is off, assuming the battery 204 is initially fully charged. For high-capacity batteries, the duration may be significantly longer. If the vehicle is plugged in to an electrical power source, the duration may be indefinite.

The control system 300 may deactivate at least some of the seating area loudspeakers 206C in the second operating mode 412 to prolong battery life, as their sound may be muffled to users congregated outside the vehicle 1 around the rear cargo area 2.

With the powertrain 201 off in the second operating mode 412, the wireless communication interface 210, if present, may also remain active so that the user does not have to enter the cabin 3 to control audio settings or playback. The electrical receptacle 207, if present, may also remain active.

The second operating mode 412 requires the tailgate closure 506 to be in an open state. Requiring the tailgate closure 506 to be in an open state may comprise a requirement that the degree of opening of the tailgate closure 506 is at a target value, equal to the fully open value or closer to the fully open value than the fully closed value. The target value may be a high enough angle that a user can sit on the aft edge of the rear cargo area 2 with clearance above their head to the upper tailgate closure 506.

Alternatively, in a semi-automated implementation, the target value may be lower such that a user still needs to manually open the tailgate closure 506 the rest of the way. The control system 300 is configured to receive an indication of a degree of opening of the closure from a closure sensor 214 (FIG. 2) of the vehicle 1, such as a hall effect sensor, to indicate how open the tailgate closure 506 is.

In response to activation of the second operating mode 412, the control system 300 may be configured to output a control signal to cause a rear tailgate actuator 505 to open the tailgate closure 506 to an open position corresponding to the target value. If the vehicle 1 lacks a rear tailgate actuator 505 or said actuator 505 is unavailable, the control system 300 may cause output of an audible and/or visual user prompt to request the user to open the tailgate closure 506 manually.

In a split tailgate implementation, the second operating mode 412 may require either one or both of the upper tailgate closure 506 and the lower tailgate closure 508 to be in an open state, respectively. Therefore, references below to opening the upper tailgate closure 506 may further include controlling another one of the actuator 505 to open the lower tailgate closure 508.

A collision sensor may be provided to detect if the upper tailgate closure 506 is about to collide with an object, or has collided with an object, when opening. If a collision indicated by the collision sensor would prevent the target value of the degree of opening of the tailgate closure 506 from being reached, the transition 408 to the second operating mode 412 may be cancelled, or paused while the control system 300 causes rendering of an alert to the user.

Another optional tailgate event feature is for hands-free telephony to be automatically disabled in the second operating mode 412 despite wireless audio being available, so that an incoming call or notification does not interrupt the playback of music/audio.

Another optional tailgate event feature is for a hands-free powered tailgate request function (gesture tailgate function) to be automatically disabled in the second operating mode 412. A hands-free powered tailgate request function is a function that is configured to initiate powered closing and/or opening of one or more tailgate closures 506, 508 by a powered tailgate system in dependence on a detected hands-free user action, such as a gesture and/or voice command. Inhibiting the function in the second operating mode 412 enables users sitting on the edge of the rear cargo area 2 to tuck their feet under the rear bumper of the vehicle 1 without triggering a tailgate close command from a bumper-mounted sensor.

Another optional tailgate event feature is for at least part of a proximity-based vehicle locking function (walkaway locking function) to be automatically disabled in the second operating mode 412, so that users can walk away from the vehicle 1 without an audible sound (e.g., chime) being rendered. The function of the audible sound may be to act as a warning that is rendered via a loudspeaker(s) 206 when a device of the user is detected to be away from the vehicle 1 if a closure of the vehicle 1 is detected as open (such as the tailgate closure(s) 506, 508).

Another tailgate event feature is for the second vehicle microphone 212 to remain active in the second operating mode 412, to enable the hands-free virtual assistant function to more reliably recognise voice commands from users at the rear cargo area 2. This enables users congregated outside the vehicle 1 to control the control system 300 via one or more of the voice commands listed below:
One or more media playback voice commands while in the second operating mode 412, such as volume control, source selection, playback controls (one or more of: play, pause, next, skip, forward, backward);
A status information request voice command while in the second operating mode 412, requesting information indicative of a state of charge of the battery 204;
A first mode-transition voice command 404, requesting the second operating mode 412 while in the first operating mode 402 (e.g., “Activate tailgate event experience”); or
A second mode-transition voice command 414, requesting the first operating mode 402 while in the second operating mode 412 (e.g., “Deactivate tailgate event experience”).

Depending on the implementation, the hands-free virtual assistant function may be a native/on-board function not requiring a server connection, or may comprise a third-party component requiring a connection of the control system 300 to a remote server for interpreting voice commands.

FIG. 4 illustrates an entry condition 406 for transitioning 408 from the first operating mode 402 to the second operating mode 412. The entry condition 406 may comprise a user entry condition. That is, the second operating mode 412 is a user-requestable operating mode, requestable when the user wants the tailgate event experience.

The second operating mode 412 is requestable via any arbitrary one of a plurality of different human-machine interfaces, including microphones 208, 212 to enable voice commands. The control system 300 is configured to receive the first mode-transition voice command 404 from the first vehicle microphone 208. The control system 300 is also configured to receive the first mode-transition voice command 404 from the second vehicle microphone 212.

Further, the control system 300 may be configured to receive a first mode-transition request for the second operating mode 412 from a touchscreen (FIGS. 5, 501) or a tactile input device of the vehicle 1. The touchscreen 501 may be within user reach of the first location of the vehicle 1, e.g., reachable from the driver's seat.

The control system 300 is configured to output a control signal to initiate a mode transition 408 to the second operating mode 412 if the entry condition 406 is satisfied. The entry condition 406 comprises a plurality of preconditions. Some of the preconditions are independent preconditions which are applied regardless of which human-machine interface was used to initiate the first mode-transition request. Further, at least one of the preconditions is a dependent precondition which is applied depending on which human-machine interface was used to initiate the first mode-transition request.

First, some example independent preconditions are described:
An independent precondition may require that the engine 202 is in a non-running state, meaning that the engine 202 is not generating combustion gases.
An independent precondition can require the vehicle 1 to be secured in a stationary position by a holding device (205, FIG. 5) of the vehicle 1. The holding device 205 may comprise a parking brake (emergency brake/e-brake) or a park pawl, for example. The control system 300 may monitor this precondition based on a parking brake status, a park pawl status, the powertrain 201 being in the deactivated state, or a combination thereof.
Another independent precondition can require that there is no ongoing hands-free telephony event utilizing the loudspeaker system 206.
Another independent precondition can require that the battery 204 has an above-threshold state of charge. The above-threshold state of charge may be above 20%, above 40%, above 50%, or above another suitable percentage to enable the second operating mode to be utilized for a reasonable period of time.

The dependent precondition can require the tailgate closure 506 to be already in the open state if the first mode-transition request is a first mode-transition voice command 404 from the second vehicle microphone 212, because the second vehicle microphone 212 is arranged to detect voice inputs from the second location in the vehicle 1, associated with passengers but not with the driver of the vehicle 1. Therefore, passengers do not have permission to activate the second operating mode 412 if doing so would cause automatic opening of the tailgate closure 506.

The other human-machine interfaces, such as the first vehicle microphone 208 and touchscreen 501/tactile input device are associated with the first location of the vehicle 1 and therefore with the driver. Therefore, the dependent precondition is not applied if the first mode-transition request is from any of those other human-machine interfaces, enabling the second operating mode 412 to be entered regardless of whether the tailgate closure 506 is in the open state or a closed state.

As described above, the dependent precondition requires the tailgate closure 506 to be already in the open state. The requirement may be that the degree of opening of the tailgate closure 506 is greater than a threshold value. If less than the threshold, the tailgate closure 506 is treated by the control system 300 as being in a closed state. The threshold value may be equal to the target value for the second operating mode 412, or another value between the fully closed value and the target value, that may be closer to the target value than the fully closed value. The control system 300 may receive an indication of the degree of opening from the closure sensor, determine whether the degree of opening is greater than the threshold value, and enable the mode transition 408 to the second operating mode 412 if the degree of opening of the tailgate closure 506 is greater than the threshold value.

If the tailgate closure 506 is not in the open state (e.g., greater than threshold angle), the control system 300 may determine that the dependent precondition is satisfied and therefore that the entry condition 406 is not satisfied. The control system 300 may output a control signal to cause rendering of a message indicating that the first mode-transition voice command 404 is denied. The message may be rendered by at least an output device 314 (FIG. 3A) proximal to the second location, such as a loudspeaker 206C associated with the second location.

In a second implementation, the second operating mode 412 can be voice-activated via the second vehicle microphone 212 even if the tailgate closure 506 is not in the open state at the time of the first mode-transition voice command 404, but only if authorisation of the first mode-transition voice command 404 is given by an authorised user such as the driver. For example, the dependent precondition may require an authorisation signal to be received by the control system 300, from a second human-machine interface other than the second vehicle microphone 212. The second human-machine interface may be associated with the first location/driver, such as the first vehicle microphone 208, touchscreen 501, tactile input device, and/or hand-portable computing device.

In the second implementation, if the control system 300 determines that the tailgate closure 506 is not in the open state when the first mode-transition voice command 404 is received from the second vehicle microphone 212, the control system 300 may output a control signal to an output device 314 associated with the second human-machine interface, requesting an authorised user to provide authorisation. Then, if the authorisation signal is received, the control system 300 may initiate the transition 408 to the second operating mode 412. The control system 300 may output the control signal to cause the rear tailgate actuator 505 to open the tailgate closure 506.

Therefore, the above description shows that a dependent precondition can be introduced so that the entry condition 406 is different depending on which human-machine interface the first mode-transition request was received from. In the example described above, the entry condition 406 is different depending on which one of the first and second vehicle microphones 208, 212 the request (first mode-transition voice command 404) was received from.

When the entry condition 406 is satisfied and before the control system 300 outputs the control signal to the actuator 505, the control system 300 may be configured to output a control signal to cause an output device 314 to prompt a user to provide a closure-actuation initiation input. For example, the prompt may comprise a ‘start’ button rendered on a touchscreen 501 which the user can touch to provide the input. The prompt may be rendered by the loudspeaker system 206 to elicit the input as a voice command. Once the closure-actuation initiation input is received, the control system 300 is configured to output the control signal to the actuator 505 to move the tailgate closure 506 of the vehicle 1 to the target value.

Initiating the mode transition 408 to the second operating mode 412 may comprise outputting a control signal to the actuator 505 to open the tailgate closure 506. If the tailgate closure 506 is already in the open state, initiating the mode transition 408 may comprise outputting a control signal to control the loudspeaker system 206 to direct the audio output to the vehicle-rearward location, among other control signals to control the other functions of the second operating mode 412.

During the actuation, the control system 300 may further cause rendering of a rear-facing camera video feed on a display (e.g., the touchscreen 501) to show the external environment in which the tailgate closure 506 is moving. A ‘stop’or ‘pause’button may be rendered on the touchscreen 501 or assigned to a tactile button.

FIG. 4 also illustrates the exit condition 416 for transitioning 418 from the second operating mode 412 to the first operating mode 402. Various example events satisfying the exit condition 416 are described below.

In some examples, the exit condition 416 can be satisfied if an independent precondition of the entry condition 406 is no longer being satisfied, such as the user activating the powertrain 201 or at least the engine 202, or the parking brake and/or park pawl being released, or a combination thereof.

In some examples, the exit condition 416 can be satisfied by detecting closing of a tailgate closure 506 and/or 508.

In some examples, the exit condition 416 can be satisfied by a second mode-transition request from a user, requesting the first operating mode 402 while the control system 300 is in the second operating mode 412. The control system 300 may be configured to receive the second mode-transition request from any one or more of the human-machine interfaces described earlier. Further, the request can be in the form of a voice command. The control system 300 may be configured to receive the second mode-transition voice command 414 from the first vehicle microphone 208. The control system 300 is configured to receive the second mode-transition voice command 414 from the second vehicle microphone 212.

An advantage of enabling the second vehicle microphone 212 to receive the second mode-transition voice command 414 is that at the end of a tailgate event, the users are likely to be in the vicinity of the tailgate and may not intend to re-enter the vehicle 1. Therefore, being able to deactivate the second operating mode 412 from outside the vehicle 1 is convenient.

Further, the exit condition 416 may not have a ‘dependent precondition’ as described earlier, meaning that the second mode transition 418 is enabled regardless of whether the closure is in the open state or the closed state when the second mode-transition voice command 414 is received from the second vehicle microphone 212. This simplifies the process of ending a tailgate event.

In some examples, the control system 300 may apply the same preconditions to all of the described voice commands described herein, other than the first mode-transition voice command 404, regardless of whether the voice commands are received from the first and second vehicle microphones 208, 212.

The exit condition 416 can comprise an energy use precondition in order to prevent the battery 204 from being drained excessively. The control system 300 monitors the energy use precondition to determine when to transition 418 back to the first operating mode 402 (e.g., un-pause the timer to resume shutdown). The control system 300 enables the second operating mode 412 as long as a monitored energy availability (e.g., state of charge) of the battery 204 is greater than a depletion limit of the battery 204. Assuming the battery 204 was initially charged, this should provide a much longer duration of use of the loudspeaker system 206 and other electrical features than would be permitted by the timer.

When the exit condition 416 is satisfied, the control system 300 outputs a control signal to initiate the second mode transition 418 to the first operating mode 402. Initiating the second mode transition 418 to the first operating mode 402 may comprise unpausing the timer to resume vehicle shutdown. Initiating the second mode transition 418 to the first operating mode 402 may also comprise outputting a control signal to the actuator 505 to close the tailgate closure(s) 506, 508, if the tailgate closure is in a state other than the closed state.

FIG. 5 is a storyboard illustrating an example non-limiting implementation of the control methods described herein. Five panels illustrate five steps/times T1-T5.

Panel T1 of FIG. 5 figuratively illustrates some example preconditions of the entry condition 406 for transitioning to the second operating mode 412 of FIG. 4. A first precondition is that the battery 204 has a state of charge above a threshold. A second precondition is that the vehicle 1 is secured in a stationary position as described earlier. Other preconditions may be as described earlier.

Panel T2 figuratively illustrates how a user may request the second operating mode 412. For example, the option to activate the second operating mode 412 may be a menu item in a touchscreen display 501 of a centre console or instrument cluster. Additionally, or alternatively, the second operating mode 412 can be requested wirelessly by a first mode-transition voice command 404 detected by the first or second vehicle microphone 208, 212.

Panel T3 figuratively illustrates how the second operating mode 412 may require a rear tailgate 504 of a rear cargo area 2 of the vehicle 1 to be opened. For example, where the rear tailgate 504 is a powered tailgate, the control system 300 may cause a rear tailgate power mechanism 505 to open the rear tailgate 504 automatically when the second operating mode 412 is initiated. In the illustrated example, the tailgate 504 is a split tailgate comprising an upper tailgate closure 506 and a lower tailgate closure 508, one or both of which may be powered. The lower tailgate closure 508 may be configured to fold down so that a user can sit on the lower tailgate closure 508 or on a tailgate seat 514 (panel T5) supported at least partially by the lower tailgate closure 508.

Panel T4 figuratively illustrates useful tailgate event functions of the second operating mode 412. One or more rear tailgate closure loudspeakers 206T may be kept active despite the powertrain 201 being in the deactivated state. Cabin-mounted loudspeakers such as seating area loudspeakers 206C may be deactivated to preserve battery life, since they are not necessarily needed during a tailgate event. The rear cargo area lamp 512 is secured to the tailgate panel 506 for the user's convenience. Other features described earlier but not visible in FIG. 5 may be present.

Panel T5 figuratively illustrates the user deploying an optional tailgate seat 514 such as a deployable seat base and/or deployable seat back for one or more users, to allow the user to comfortably sit in the rear cargo area 2 of the vehicle 1 while enjoying their tailgate event. The tailgate seat 514 may be attachable to one or more attachment points 515 or may be an integrated feature of the rear cargo area 2.

When the user is finished with their tailgate event, they may initiate the second mode transition 418 back to the first operating mode 402 as described earlier.

With reference to FIG. 3A, there is illustrated a control system 300 for a vehicle 1. The control system 300 comprises one or more controllers 301.

The control system 300 is configured to receive data from one or more sensors such as voice commands from the first or second vehicle microphone 208, 212. Where the data is a voice command from the second vehicle microphone 212 (as shown in FIG. 3A), the control system 300 is configured to determine whether the entry condition 406 is satisfied. If satisfied, the control system 300 may then output a control signal to control the actuator 505 when initiating the mode transition to the second operating mode 412.

The control system 300 as illustrated in FIG. 3A comprises one controller 301, although it will be appreciated that this is merely illustrative. The controller 301 comprises processing means 304 and memory means 306. The processing means 304 may be one or more electronic processing devices 304 which operably execute computer-readable instructions. The memory means 306 may be one or more memory devices 306. The memory means 306 is electrically coupled to the processing means 304. The memory means 306 is configured to store instructions, and the processing means 304 is configured to access the memory means 306 and execute the instructions stored thereon.

The controller 301 comprises an input means 310 and an output means 312. The input means 310 may comprise an electrical input 310 of the controller 301. The output means 312 may comprise an electrical output 312 of the controller 301. The controller 301 may have an interface 302 comprising an electrical input/output I/O 310, 312, or an electrical input 310, or an electrical output 312, for receiving information and interacting with external components. The input 310 is arranged to receive the voice commands from the first and second vehicle microphones 208, 212. The voice commands are electrical signals which are indicative of logical computer instructions, and are determined by a speech recognition algorithm (local or remote to the control system 300) from voice inputs detected by the first and second vehicle microphones 208, 212. In this manner, a voice command is ‘from’ a microphone. The output 312 is arranged to output an actuator control signal, indicative of a requirement for the actuator to move the tailgate closure to the open state.

FIG. 3B illustrates a non-transitory computer-readable storage medium 330 comprising the instructions (computer software).

FIG. 4 illustrates a method 400 according to an embodiment of the invention. The method 400 is a primarily method of controlling a loudspeaker system 206 of a vehicle 1, as this is a useful function of the operating modes. In particular, the method 400 is a method of controlling an operating mode of a control 300 system of the vehicle 1. The method 400 may be performed by the control system 300 illustrated in FIG. 4. In particular, the memory 306 may comprise computer-readable instructions 308 which, when executed by the processor 304, perform the method 400.

It is to be understood that the or each controller 301 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 301 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 301 to implement the control techniques described herein (including some or all of the functionality required for the method(s) described herein). The set of instructions 308 could be embedded in said one or more electronic processors 304 of the controller 301; or alternatively, the set of instructions 308 could be provided as software to be executed in the controller 301. A first controller or control unit may be implemented in software run on one or more processors. One or more other controllers or control units may be implemented in software run on one or more processors, optionally the same one or more processors as the first controller or control unit. Other arrangements are also useful.

The, or each, electronic processor 304 may comprise any suitable electronic processor (e.g., a microprocessor, a microcontroller, an ASIC, etc.) that is configured to execute electronic instructions 308. The, or each, electronic memory device 306 may comprise any suitable memory device and may store a variety of data, information, threshold value(s), lookup tables or other data structures, and/or instructions therein or thereon. In an embodiment, the memory device 306 has information and instructions for software, firmware, programs, algorithms, scripts, applications, etc. stored therein or thereon that may govern all or part of the methodology described herein. The processor, or each, electronic processor 304 may access the memory device 306 and execute and/or use that or those instructions and information to carry out or perform some or all of the functionality and methodology described herein.

The at least one memory device 306 may comprise a computer-readable storage medium (e.g. a non-transitory or non-transient storage medium) that may comprise any mechanism for storing information in a form readable by a machine or electronic processors/computational devices. Examples of the form include, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

It will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application. The input devices arranged to receive user inputs from the different first and second locations in the vehicle are not limited to being vehicle microphones. For example, the input devices can comprise different touch input devices such as touchscreens (including touchscreen 501) or buttons. Therefore, the control system is configured to:
receive the first mode-transition request from any one of a first user input device of the vehicle 1 and a second user input device of the vehicle 1, wherein the first user input device is arranged to detect user input from a first location in the vehicle 1, wherein the second user input device is arranged to detect user input from a second location in the vehicle 1;
determine whether the entry condition 406 is satisfied, wherein the entry condition 406 is different depending on which one of the first and second user input devices the first mode-transition request was received from; and
output a control signal to initiate a mode transition 408 to the second operating mode 412, in dependence on the entry condition 406 being satisfied.

In further alternative examples, the closure of the vehicle is other than a tailgate closure 506, 508. The blocks illustrated in FIG. 4 may represent steps in a method and/or sections of code in the computer program 308. The illustration of a particular order to the blocks does not necessarily imply that there is a required or preferred order for the blocks and the order and arrangement of the block may be varied. Furthermore, it may be possible for some steps to be omitted.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. A control system for controlling a loudspeaker system of a vehicle, the control system comprising one or more controllers, wherein in a first operating mode the control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the control system is configured to:
receive a mode-transition voice command from any one of a first vehicle microphone and a second vehicle microphone, wherein the first vehicle microphone is arranged to detect voice input from a first location in the vehicle, wherein the second vehicle microphone is arranged to detect voice input from a second location in the vehicle, wherein the mode-transition voice command requests the second operating mode;
determine whether an entry condition is satisfied, wherein the entry condition is different depending on which one of the first and second vehicle microphones the mode-transition voice command was received from; and
output a control signal to initiate a mode transition to the second operating mode, in dependence on the entry condition being satisfied.

2. The control system of claim 1, wherein the entry condition enables the mode transition regardless of whether the closure is in the open state or a closed state when the mode-transition voice command is from the first vehicle microphone, and wherein the entry condition enables the mode transition if the closure is in the open state but not if the closure is in the closed state when the mode-transition voice command is from the second vehicle microphone.

3. The control system of claim 2, configured to receive an indication of a degree of opening of the closure from a closure sensor of the vehicle, and determine whether the degree of opening of the closure is greater than a threshold value between fully closed and fully open values, wherein the entry condition enables the mode transition if the degree of opening of the closure is greater than the threshold when the mode-transition voice command is from the second vehicle microphone.

4. The control system of claim 1, configured to control an actuator of the vehicle to move the closure of the vehicle between open and closed positions, when transitioning between the first and second operating modes.

5. The control system of claim 4, wherein when the entry condition is satisfied, the control system is configured to output a control signal to cause an output device to prompt a user to provide a closure-actuation initiation input, and control the actuator to move the closure of the vehicle between the open and closed positions in dependence on receiving the closure-actuation initiation input.

6. The control system of claim 1, wherein the first vehicle microphone comprises a front cabin microphone arranged to detect voice inputs from the first location, the first location comprising a driver's seat, and wherein the second vehicle microphone comprises a rear cabin microphone arranged to detect voice inputs from the second location, the second location comprising a rear seat behind the driver's seat.

7. The control system of claim 1, configured to:
receive a second mode-transition voice command from the second vehicle microphone, wherein the second mode-transition voice command requests the first operating mode while the control system is in the second operating mode; and
output a control signal to initiate a second mode transition to the first operating mode, in dependence on receiving the second mode-transition voice command.

8. The control system of claim 7, configured to enable the second mode transition regardless of whether the closure is open or closed when the second mode-transition voice command is from the second vehicle microphone.

9. The control system of claim 1, wherein the closure is a tailgate closure of the vehicle.

10. The control system of claim 1, wherein in the second operating mode the control system is configured to control the loudspeaker system to direct audio output to a vehicle-rearward location relative to audio output in the first operating mode.

11. The control system of claim 10, wherein directing audio output to the vehicle-rearward location comprises activating or increasing a sound pressure level of a rear loudspeaker of the loudspeaker system relative to a front loudspeaker of the loudspeaker system, and/or deactivating or decreasing the sound pressure level of the front loudspeaker of the loudspeaker system.

12. The control system of claim 1, wherein the second operating mode requires one or more of the following conditions to be satisfied:
an internal combustion engine of the powertrain is in a non-running state;
the vehicle is secured in a stationary position by a holding device of the vehicle; or
an electrical energy storage means of the vehicle has an above-threshold state of charge.

13. A vehicle comprising the control system of claim 1.

14. A method of controlling a loudspeaker system of a vehicle, wherein in a first operating mode a control system is configured to deactivate the loudspeaker system in dependence on a powertrain of the vehicle entering a deactivated state, wherein in a second operating mode the control system is configured to enable the loudspeaker system to be used while the powertrain is in the deactivated state, wherein the second operating mode requires a closure of the vehicle to be in an open state, and wherein the method comprises:
receiving a mode-transition voice command from any one of a first vehicle microphone and a second vehicle microphone, wherein the first vehicle microphone is arranged to detect voice input from a first location in the vehicle, wherein the second vehicle microphone is arranged to detect voice input from a second location in the vehicle, wherein the mode-transition voice command requests the second operating mode;
determining whether an entry condition is satisfied, wherein the entry condition is different depending on which one of the first and second vehicle microphones the mode-transition voice command was received from; and
outputting a control signal to initiate a mode transition to the second operating mode, in dependence on the entry condition being satisfied.

15. Computer readable instructions which, when executed by a computer, are arranged to perform the method of claim 14.
